(19) United States
(12) Patent Application Publication
(10) Pub. No.: US 2004/0247842 A1
(43) Pub. Date: Dec. 9, 2004

(54) Electronic substrate, electronic circuit and method and device for manufacture of the same

(76) Inventors: Minoru Koyama, Matsumoto-shi (JP); Yasunori Yamazaki, Nagano-ken (JP)

Correspondence Address: HARNESS, DICKEY & PIERCE, P.L.C., P.O. BOX 828, BLOOMFIELD HILLS, MI, 48303, US

(21) Appl. No.: 10/816,222

(22) Filed: Apr. 1, 2004

(30) Foreign Application Priority Data
May 28, 2003 (JP) 2003-151059

(51) Int. Cl. B05D 5/12

(52) U.S. Cl. 428/195.1; 427/96.1

(57) ABSTRACT

This device for manufacture of an electronic circuit forms a desired circuit pattern P by permeating liquid material (10, 40) including a material for circuit pattern formation into a permeable electronic substrate (100). This device for manufacture comprises an ink jet type head (20, 50) which discharges liquid material (10, 40) against an electronic substrate (100), and a shifting device (70) which relatively shifts the ink jet type head (20, 50) and the electronic substrate (100) with respect to one another.

Priority is claimed on Japanese Patent Application No. 2003-151059, filed May 28, 2003, the content of which is incorporated herein by reference.

### BACKGROUND OF THE INVENTION

1. Field of the Invention

The present invention relates to a manufacturing technique for an electronic circuit, and more particularly relates to a manufacturing technique for an electronic circuit, which can create any desired electronic circuit by permeating a material for forming a circuit pattern into an electronic substrate which has the characteristic of permeability.

2. Description of Related Art

In the past, a photolithographic technique has been used in order to form a minute electronic circuit pattern for an electronic device such as, for example, a semiconductor integrated circuit or the like. Since the processes of making a photographic plate, resist painting, exposure, development and the like have been necessary for the manufacture of an electronic circuit using a photolithographic technique, it has not been possible to manufacture an electronic circuit except in a semiconductor plant in which the appropriate equipment is set up. Furthermore, for production of electronic circuits, it is often the case that manufacturing equipment such as an insertion machine, a flux tank, a soldering tank and the like is required, so that high equipment investment and complicated process management are necessary. Due to this, in cases such as small product runs when manufacturing a prototype for an electronic circuit or the like (for example, manufacture of a prototype in which the developer fits a large number of components using an all-purpose substrate, solders them, and so on), prior art methods have been rather unsuitable, and have entailed much labor and a lot of time.

As a technique for solving this type of problem, it has been considered to answer the requirement for small quantities of electronic circuits in a manner that does not require large scale equipment by making a circuit by discharging material for forming the circuit upon the upper surface of an electronic substrate using an ink jet technique.

With this technique, it becomes possible to satisfy the requirement for manufacture of small scale production of various types of product, but, on the other hand, it cannot be said that it has sufficiently satisfied demands for reduction of the size and the weight of electronic circuits, the call for which is becoming more and more stringent nowadays. In other words, along with the increase in the capacity of semiconductor memory and increase in the speed and progressive advance of large scale integration of CPU processors, the requirement of reduction of the size of electronic circuits has become extremely demanding in recent years, and nowadays there is a demand for a method for forming electronic circuits upon the upper surface of an electronic substrate, which is improved upon prior art methods.

The present invention has been conceived in the light of the above described situation, and its objective is to provide an electronic substrate, an electronic circuit, and a method for manufacture and a device for manufacture of the same, which, by forming any desired electronic circuit within an electronic substrate by permeating the materials for circuit pattern formation into an electronic substrate which is endowed with permeability, can satisfy the requirement for reduction of the size, the weight, and the thickness of an electronic circuit.

### SUMMARY OF THE INVENTION

According to a principal aspect thereof, the present invention proposes an electronic substrate, made from a porous material into which a fluid material which includes a material for formation of a circuit pattern can permeate. Since, with this electronic substrate, the porous material exhibits an excellent capillary phenomenon, it is possible quickly to absorb the liquid material which includes the material for circuit pattern formation into the substrate, and it is accordingly possible to form a circuit pattern of high accuracy.

A main component of the porous material may be a ceramic. In this case it is possible to form a circuit pattern of high accuracy, since such a porous material not only exhibits an excellent capillary phenomenon, but also is endowed with the characteristic of being an insulator, the characteristic of being resistant to heat, the characteristic of chemical resistance, and the characteristic of lightness in weight.

Moreover, a main component of said porous material may be a fiber material. In this case, also, it is possible to form a circuit pattern of high accuracy, since such a porous fiber material exhibits an excellent capillary phenomenon.

According to another principal aspect thereof, the present invention also proposes an electronic circuit, comprising an electronic substrate of which main component is a ceramic material or a fiber material, and a circuit pattern which is formed by the liquid material which includes a material for formation of a circuit pattern permeating into the electronic substrate and solidifying. According to this electronic circuit, the circuit pattern is formed within the electronic substrate. Accordingly, it is possible to implement reduction in size and weight of the electronic circuit, as compared to the case in which the circuit pattern is formed upon the upper surface of the electronic substrate, since it is possible to reduce the thickness of the electronic circuit.

As this material for circuit pattern formation, this liquid material may include at least one of a conductive material, a semiconducting material, an insulating material, and a dielectric material. In this case, it is possible to form electronic circuits of various different types.

This circuit pattern may include a condenser which is formed by the material for circuit pattern formation. In this case, it is possible to provide an element in the electronic circuit which can accumulate and discharge electricity.

The circuit pattern may include an inductance which is formed by the material for circuit pattern formation. In this case, it is possible to provide an element in the electronic circuit which can easily pass current at low operational frequencies, and which does not easily pass current at high operational frequencies.

The circuit pattern may include a resistor which is formed by the material for circuit pattern formation. In this case, it is possible to provide an element in the electronic circuit which offers an appropriate resistance to the passage of electrical current.

The circuit pattern may include a lead wire or an electrode which is formed by the material for circuit pattern formation. In this case, it is possible to provide this electronic circuit with a connection to a component for conducting an electrical current, or to some other electronic circuit.

The circuit pattern may include an active element which is formed by the material for circuit pattern formation. In this case it is possible, for example, to provide this electronic circuit with an element which only conducts electrical current in one direction, or the like.

According to yet another principal aspect thereof, the present invention also proposes a method for manufacture of an electronic circuit, in which a circuit pattern is formed upon a permeable electronic substrate by permeating a liquid material which includes a material for circuit pattern formation thereinto and solidifying it. According to this method for manufacture of an electronic circuit, the circuit pattern is formed within the electronic substrate. Accordingly, with this manufacturing method, it is possible to implement reduction in the size and in the weight of the electronic circuit, since it is possible to make the electronic circuit thinner, as compared to the prior art case of forming the circuit pattern upon the upper surface of the electronic substrate.

According to a still yet another principal aspect thereof, the present invention also proposes a device for manufacture of an electronic circuit which forms a desired circuit pattern upon a permeable electronic substrate using a liquid material which includes a material for circuit pattern formation. In detail, this device for manufacture of an electronic circuit includes an ink jet type head which discharges the liquid material against the electronic substrate, and a shifting device which relatively shifts the ink jet type head and the electronic substrate with respect to one another. With this device for manufacture of an electronic circuit, it is possible to utilize an ink jet technique which is analogous to the one which is utilized in the prior art. Accordingly, with this device for manufacture of an electronic circuit, it is possible to manufacture a small sized and lightweight electronic circuit easily and conveniently.

### BRIEF DESCRIPTION OF THE DRAWINGS

FIG. 1 is a structural diagram of a device for manufacture of an electronic circuit according to the present invention.

FIG. 2 is an exploded perspective view of an ink jet type head, and FIG. 3 is a partial cross sectional perspective view showing an essential portion of this ink jet type head.

FIGS. 4A, 4B, 5A, and 5B are views, showing two different methods of forming a condenser.

FIGS. 6A, 6B, 7A and 7B are views, showing a method of forming a coil.

FIGS. 8A, 8B, 9A and 9B are views, showing a method of forming a resistor.

FIGS. 10A and 10B are views, showing a method of forming a lead wire and an electrode.

FIGS. 11A and 11B are views, showing a method of forming a lead wire.

FIGS. 12A and 12B are views, showing a method of forming an active element.

### DETAILED DESCRIPTION OF THE INVENTION

In the following, preferred embodiments of the electronic substrate, the electronic circuit, and the method and the device for manufacture of an electronic circuit according to the present invention will be explained with reference to the appended drawings.

The electronic substrate 100 which is used in the preferred embodiments of the present invention is made from a porous material, the principal material of which is a fiber material such as, for example, silica fiber or alumina fiber or the like, or a ceramic material.

Here, this porous ceramic material which is manufactured so as to be able to tolerate high temperature is endowed with a unique three dimensional reticulated structure which is formed by melting a portion of a high melting point ceramic material and fusing it with a portion of the same ceramic material. Since, with this three dimensional structure, a multitude of very small holes having smooth wall surfaces become connected together due to reaction at high temperature, the ratio of air holes in the resulting ceramic porous material is high, so that it contains a large number of connected empty holes (voids) whose average diameter is of the order of several tens of micrometers. Due to this, this porous ceramic material exhibits an excellent capillary performance, and it is possible to cause it to absorb various liquid materials at relatively high speed.

Since the ceramic material which is utilized for this porous ceramic material is, in many cases, a semiconducting or insulating oxide, the resulting porous ceramic material will be an insulator. In addition to the various functions and characteristics which are appropriate to a porous material, such as lightness in weight, adiathermicity, good sound absorption quality, good absorption and separation characteristics, and selectable transparency, such a porous ceramic material is endowed with various qualities which are appropriate for a ceramic material, such as resistance to temperature, chemical resistance, and the like; and the details of its performance are determined by the shape of its holes, the diameter of its holes, the state of distribution of the diameters of its holes, and so on. Accordingly, by appropriately controlling the shape of the holes in such a porous ceramic material, the diameters of these holes, the state of distribution of the diameters of these holes, and so on, it is possible to conform to a wide range of requirements, so that the porous ceramic material can be developed in answer to a wide range of applications.

Accordingly, an electronic substrate 100 which is formed from a porous ceramic material which has this type of characteristics is endowed with permeability for quickly absorbing various types of liquids, a good insulating characteristic, a good heat resistance characteristic, good chemical resistance characteristics, and lightness in weight. It is possible to obtain an electronic substrate 100 which is suitable for the formation of various types of circuit pattern P by varying in an appropriate manner the size and the thickness of this electronic substrate 100, the shape of its holes, the diameter of its holes, the state of distribution of the diameters of its holes, and so on.

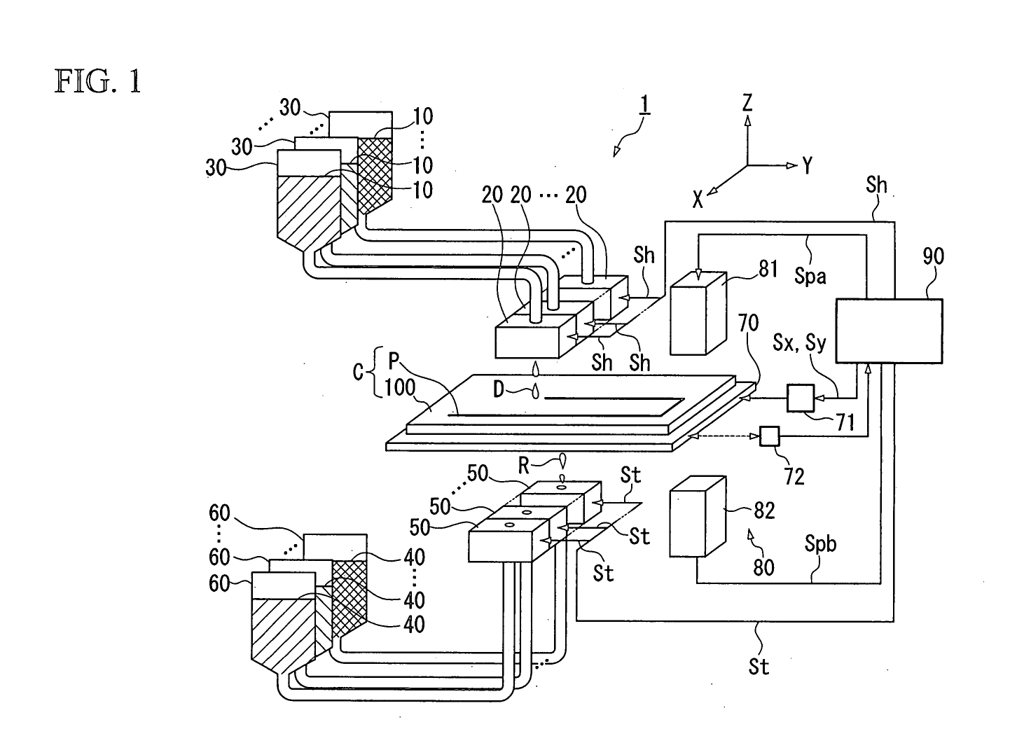

FIG. 1 is an overall diagram showing a device for manufacture of an electronic circuit according to the present invention. This device for manufacture of an electronic circuit 1 comprises one or more ink jet type heads 20 and one or more ink jet type heads 50, one or more tanks 30 and one or more tanks 60, a stage device 70, a solidification device 80, and a control device 90 so as to manufacture an electronic circuit C by forming a predetermined circuit pattern P in the interior of an electronic substrate 100 by discharging drops D and R of liquid using an ink jet method against the surfaces of the electronic substrate 100, thus permeating these liquid drops D and R into the electronic substrate 100.

The ink jet type heads 20 and the ink jet type heads 50 have the same structure as one another, and they are arranged so as to confront the electronic substrate 100, which is mounted upon the stage device 70, upon both its sides, thus sandwiching it between them; and they discharge liquid drops D and R against their respective sides of said electronic substrate 100.

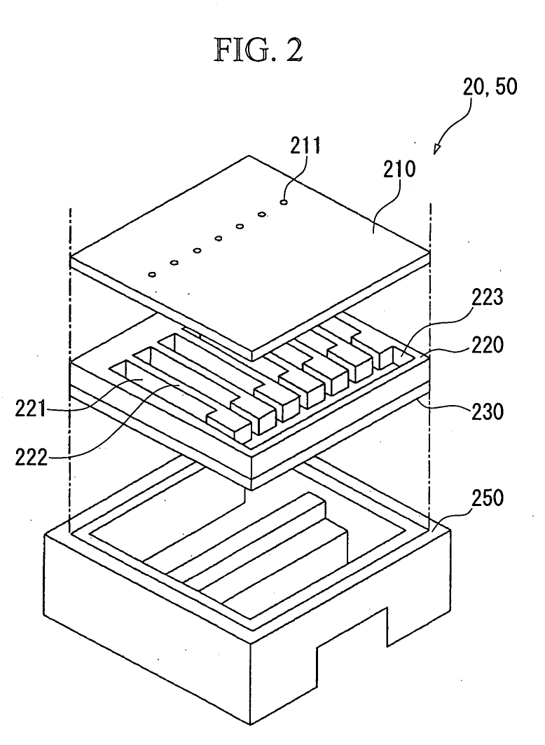

FIG. 2 is an exploded perspective view for explanation of one example of the structure of the ink jet type heads 20 and the ink jet type heads 50. As shown in FIG. 2, the ink jet type heads 20 and 50 are each made by housing a nozzle plate 201 which is provided with nozzles 211, a pressure chamber definition substrate 200, and a vibratory plate 230 within a housing 250.

The essential portion of this ink jet type head 20, as shown in FIG. 3, is made by sandwiching the pressure chamber definition substrate 220 between the nozzle plate 210 and the vibratory plate 230. A number of void chambers which are separated by side walls (partition walls) 222 are provided in the pressure chamber definition substrate 220, which is formed by etching a single crystal silicon substrate or the like. In more detail, a plurality of cavities 221, supply apertures 224 which lead to each of these cavities 221, and a reservoir 223 which is a common flow path leading to the various supply apertures 224 are formed by respectively disposing the nozzle plate 210 and the vibratory plate 230 upon the upper and lower surfaces of the pressure chamber definition substrate 220, thus closing off the tops and the bottoms of the spaces defined thereby. Each of these cavities 221 is connected to the reservoir 223 via its one of the supply apertures 224, and functions as an individual pressure chamber.

A plurality of nozzles 211 which lead to the cavities 221 are formed in the nozzle plate 210. The vibratory plate 230 is made, for example, as a heat oxidized film or the like. An ink tank aperture 231, which leads to the reservoir 223, is provided in the vibratory plate 230. Any desired liquid material 10, 40 which has been charged into a tank 30, 60 can be supplied to the reservoir 223 via this ink tank aperture 231. Piezoelectric elements 240 which correspond to each of the cavities 221 are provided above the vibratory plate 230. These piezoelectric elements 240 are each made by sandwiching a crystal of piezoelectric ceramic material such as a PZT element or the like between an upper electrode and a lower electrode (not shown in the drawings). These piezoelectric elements 240 undergo changes in their volume according to discharge signals Sh and St which are supplied from the control device 90.

The ink jet type heads 20 and 50 which have this kind of structure can discharge liquid drops D and R by varying the volumes of the piezoelectric elements 240. It should be understood that the ink jet type heads 20 and 50 are not to be considered as being limited to the structure disclosed above; for example, it would also be acceptable for them to be made so as to discharge the liquid drops D and R by heating up the liquid materials 10 and 40 with heating elements, so as to increase their volumes.

Returning to FIG. 1, each of the tanks 30 and the tanks 60 holds a quantity of liquid material 10, 40, and supplies this liquid material 10, 40 via a supply pipe to a one of the ink jet type heads 20, 50. It should be understood that, since there are no connections between the various tanks 30, 60, it is possible to store various different types of liquid material in the various different tanks, and to supply these different types of liquid material to the various corresponding different ink jet type heads 20, 50.

Each of the liquid materials 10, 40 includes a material for circuit pattern formation K which is intended for forming a circuit pattern P. These materials for circuit pattern formation K are substances which exhibit various different electronic characteristics when they are solidified, such as conductivity, semi-conductivity, insulation characteristic, dielectric characteristic, and the like; examples of possible such materials K for circuit pattern formation are a metallic substance of low melting point such as solder or gallium or lead or the like which can be made liquid by being heated up above its melting point, or a substance which includes minute particles of high density and which exhibits a desired electronic characteristic by simply being dried after discharge. Whatever material is utilized, the viscosities of the liquid materials 10, 40 are regulated with solvents or the like so that they are in a suitable liquid form for discharge from the ink jet type heads 20, 50 as the liquid drops D, R.

The stage device (the shifting device) 70, along with being able to hold the electronic substrate 100 in place, can also shift the electronic substrate 100 in the X direction and the Y direction. This stage device 70 is provided with a lower opening (not shown in the drawings) in the region where it is desired to form a circuit pattern upon the lower side in the drawing of the electronic substrate 100, so that it is possible for the liquid drops D, R which are discharged from the ink jet type heads 20, 50 which are disposed below the stage device 70 to arrive at the lower surface of the electronic substrate 100. Accordingly, only the peripheral portion of the lower surface in the drawing of the electronic substrate 100 contacts the stage device 70.

This stage device 70 is moved in the X direction and in the Y direction by a stage shifting section 71, according to drive signals Sx and Sy from the control device 90, so that the electronic substrate 100 which is held upon this stage device 70 is correspondingly transported in the X direction and in the Y direction. A substrate position measurement section 72 is provided to the stage device 70, and it dispatches signals to the control device 90 according to the position (in the X direction and in the Y direction) of the electronic substrate 100. And the control device 90 controls the position of the electronic substrate 100 according to these signals.

The solidification device 80 is a device which performs a predetermined type of heating processing upon the liquid drops D and R which are discharged from the ink jet type heads 20, 50 and also upon the electronic substrate 100. This solidification device 80 comprises an upper side solidification device 81 and a lower side solidification device 82, and these devices 81 and 82 perform physical, physico-chemical, and/or chemical heating processing or the like upon the liquid drops D, R and also upon the electronic substrate 100, according to control signals Spa and Spb which are supplied from the control device 90 to them respectively. As examples of such heating processing, there may be cited blowing a draft of heated air, heating and drying processing by laser irradiation or by illumination with a lamp, and chemical transformation processing by application of a chemical substance; and the solidification device 80 is provided with the appropriate structure for performing the desired such process or processes.

The control device 90 is, for example, a computer device which comprises a CPU, a memory, interface circuitry, and the like (none of which are shown in the drawing). In this device 1 for manufacture of an electronic circuit, this control device 90 implements manufacture of the electronic circuit by executing a predetermined program. In other words, it causes the discharge of the liquid drops D, R by dispatching appropriate discharge signals Sh and St to the ink jet type heads 20, 50, and also shifts the electronic substrate 100 appropriately by dispatching appropriate drive signals Sx and Sy to the stage shifting section 71.

The device 1 for manufacture of an electronic circuit having this type of structure operates as will now be described.

First, when the electronic substrate 100 is placed upon the stage device 70, the control device 90 outputs the drive signal Sx and the drive signal Sy to the stage shifting section 71. The stage shifting section 71 moves the stage device 70 in response to this drive signal Sx and this drive signal Sy, so that thereby the electronic substrate 100 is shifted relatively to the ink jet type heads 20, 50, thereby bringing the region of the electronic substrate 100 upon which the circuit pattern is to be formed to confront these ink jet type heads 20, 50.

Next, according to the type of circuit pattern P which is to be formed (i.e., according as to whether it is to be endowed with an electronic characteristic of being conductive, semi-conductive, insulating, or dielectric), the control device 90 specifies whichever of the liquid materials 10, 40 is to be utilized, and dispatches discharge signals Sh and/or St for causing this liquid material 10, 40 to be discharged to the corresponding ink jet type head 20, 50 (actually, to the piezoelectric element 240 thereof).

In the ink jet type head 20, 50 to which this discharge signal Sh, St has been supplied, the piezoelectric element 240 undergoes a change of volume according to the voltage which has been applied between its upper electrode and its lower electrode. This change of volume distorts the vibratory plate 230, and accordingly the capacity of the cavity 221 is varied. Since the liquid material 10, 40 is already charged into this cavity 221, thus this liquid material 10, 40 is discharged from the nozzle 211 of this cavity 221 in the form of liquid drops D, R towards the upper surface or the lower surface of the electronic substrate 100. The deficiency in the amount of the liquid materials 10, 40 in the cavity 221 which has been engendered by this discharge of the liquid material 10, 40 is made up by fresh supply from the tank 30, 60.

Consequently, the liquid material 10, 40 which has been adhered to the upper surface or the lower surface of the electronic substrate 100 is immediately sucked into and permeated into the electronic substrate 100 due to the permeability with which this electronic substrate 100 is endowed (by the phenomenon of capillarity). It is possible to control the depth to which the liquid material 10, 40 permeates into the electronic substrate 100 by regulating the amount and the type of the solvent which is included in this liquid material 10, 40. The liquid material which has thus been permeated into the electronic substrate 100 is solidified within the electronic substrate 100 by natural drying or by processing by the solidification device 81, 82, so as to form a solid layer. This layer is endowed with the desired electronic characteristic, such as conductivity, semi-conductivity, insulating ability, or a dielectric characteristic, according to the particular nature of the material for circuit pattern formation which is included in the liquid material 10, 40.

Next, various concrete versions of the method according to the present invention for manufacture of an electronic circuit pattern P which includes an electronic circuit component C (such as condensers 121 and 122, a coil 123, a resistor 124, a lead wire 125, an electrode 126, and an active element 127) will be explained.

Preferred Embodiment 1

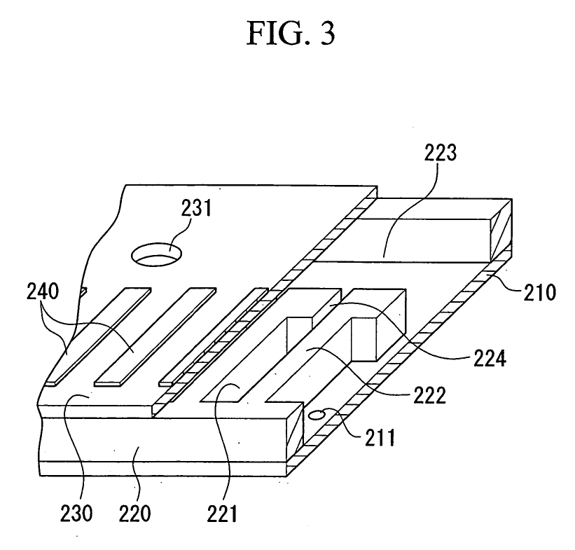

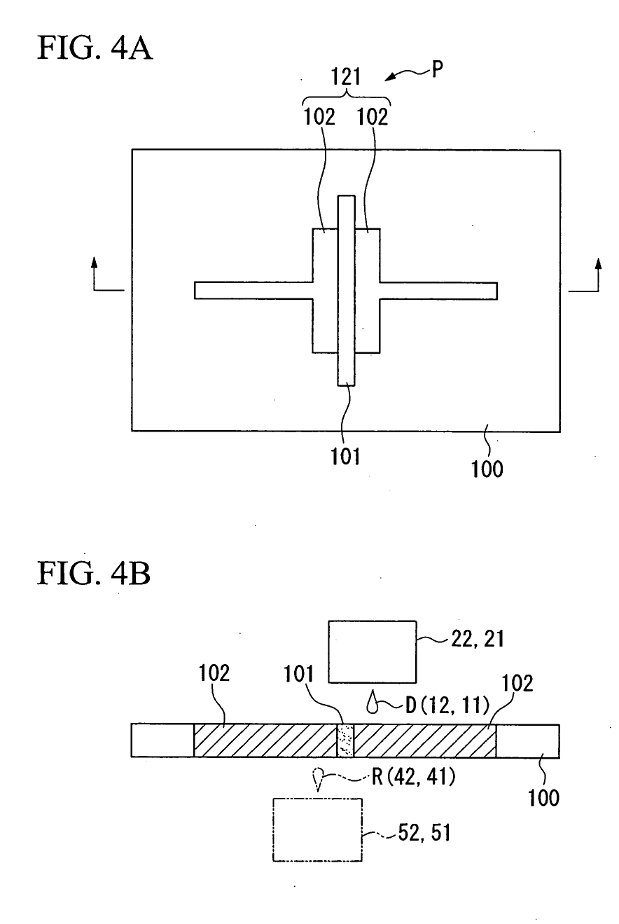

First, with reference to FIGS. 4A and 4B, an example of a method for forming, as a circuit pattern P, a condenser 121 which has electrodes which face in the direction of the surface will be explained. FIG. 4A is a plan view of the electronic circuit, while FIG. 4B is a sectional view taken in a plane shown by the arrows IV-IV in FIG. 4A. Here it will be supposed that one liquid material 11, 41 includes, as a material K for circuit pattern formation, a material which is endowed with an insulating characteristic, while another liquid material 12, 42 includes, as a material K for circuit pattern formation, a material which is conductive. This liquid material 12, 42 which is conductive may include RuO₂, IrO₂, OsO₂, MoO₂, ReO₂, WO₂, YBa₂Cu₃O₇₋ₓ, Pt, Au, Ag, In, In—Ga alloy, Ga, solder or the like as the material K for circuit pattern formation; and, as the solvent, butyl carbitol acetate, 3-dimethyl-2-imidazolithin, BMA, or the like may be employed. Or the liquid material 12, 42 which is conductive may also be a low melting point metallic film such as In—Ga alloy, In, solder or the like in a state in which it has been melted by heating or the like.

Tanks which contain the liquid materials which include a conductive material as the material K for circuit pattern formation, and ink jet type heads 22, 52 which are to discharge these liquid materials 12, 42 including this conductive material, and tanks which contain the liquid materials 11, 41 which include an insulating material as the material K for circuit pattern formation, and ink jet type heads 21, 51 which are to discharge these liquid materials 11, 41 including this insulating material, are provided to this device 1 for manufacture of an electronic circuit.

The process of forming a conductive layer:

The electronic substrate 100 is shifted relative to the ink jet type heads 22, 52 which are to discharge the liquid materials 12, 42 which are conductive and which faces the upper surface and the lower surface of this electronic substrate respectively, so as to bring said ink jet type heads 22, 52 to confront the regions upon which they are to form a conductive layer 102 upon this electronic substrate. Next, the liquid material 12, 42 which includes the conductive material as the material K for forming the circuit pattern, is discharged from the ink jet heads 22, 52 while shifting the electronic substrate 100 relative to the ink jet heads 22, 52 along the region in which the circuit pattern is to be formed, and thereby rectangular conductive layers 102 (the electrodes of the condenser 121) are formed. The liquid material 12 or 42 which has been discharged in this manner sticks to the electronic substrate 100. This stuck on liquid material 12, 42 has a diameter of about several tens of micrometers.

By doing this, two conductive layers 102, 102 are formed which constitute a pair of electrodes which are separated by a predetermined distance. The width and the length of these conductive layers 102, 102, and the gap between them, are determined according to the desired capacitance for the condenser 121 which is to be formed. This is because the capacitance of the condenser 121 is determined by the area of the electrodes (the conductive layers 102) and by the gap between them.

The process of solidifying the conductive layer:

In order to obtain the desired electronic characteristic, it is necessary to perform solidification processing of the conductive layers 102.

If, as the material K for circuit pattern formation, the liquid material 12, 42 includes minute particles of a conductive material such as a metallic substance or the like which are not in solution, then, since the liquid material 12, 42 which is discharged from the ink jet type head 22, 52 is in the state in which these minute particles are dispersed within a solvent, when the solvent is merely evaporated, it may happen that the material K for circuit pattern formation (the minute particles of the conductive material) does not connect together, so that its conductivity cannot be maintained. Accordingly, by heating up the material K for circuit pattern formation using the solidification device 80 or the like above the melting point of the conductive material which it includes, along with evaporating the solvent, it is possible to mutually connect together the minute particles which were dispersed in the material K for circuit pattern formation into a single body, thus ensuring that the conductivity of the resulting element is excellent.

If the material K for circuit pattern formation is dissolved in the liquid material 12, 42, then it is possible to precipitate the conductive material by evaporating the solvent with the solidification device 80, and in this case there is no problem with the conductivity of the resulting element.

On the other hand, if the material K for circuit pattern formation is a material such as a metallic substance or the like which has been heated up above its melting point, then it is possible to solidify it into a conducting member by keeping the region of the electronic substrate for circuit pattern formation at a temperature which is below the melting point of said metallic substance.

If it is not possible to ensure a sufficient performance for the condenser 121 because the electronic insulation characteristic between the above described two electrodes (conductive layers) 102, 102 due only to the electronic substrate 100 is too low, it will also be acceptable to form an insulating layer 101 between these electrodes (the conductive layers 102, 102). This is because the capacitance of the condenser 121 is increased by increasing the dielectric ratio between the electrodes.

Here, the liquid material 11, 41 for forming the insulating layer 101 may include, as the material for circuit pattern formation, SiO₂ or Al₂O₃ which have an insulating characteristic, SrTiO₃ which has a dielectric characteristic, BaTiO₃, Pb (Zr, Ti)O₃, or the like; and, as the solvent, PGMEA, cyclohexane, carbydol acetate or the like may be utilized. Furthermore, it would also be acceptable to add glycerin, diethylene glycol, ethylene glycol, or the like as a humectant and also as a binder for the liquid material 11, 41, according to requirements. Yet further, as the liquid material 11, 41 which includes a material which has an insulating characteristic, it would also be acceptable to utilize a metallic alkoxide including polysilazan or an insulating material. In this case, it is possible to form the insulating material by heating up, or by a chemical reaction or the like.

The process of forming an insulating layer:

The electronic substrate 100 is shifted relatively to the ink jet type heads 21, 51 which are capable of discharging the liquid material 11, 41 having an insulating characteristic against the upper and the lower surfaces of the electronic substrate 100 respectively, and the liquid material 11, 41 is discharged from these ink jet type heads 21, 51 towards the region (between the conductive layers 102, 102) where the insulating layer 101 is to be formed. The width and the depth of the insulating layer 101 which is laid down between the electrodes 102, 102, and the dielectric ratio of the material which is endowed with an insulating characteristic, are determined according to the capacitance which is desired for the condenser 121 which is to be formed. The capacitance of the condenser 121 is also determined by the dielectric ratio between the electrodes.

If the liquid material 11, 41 includes a material which is endowed with an insulating characteristic, then it will also be acceptable simply to evaporate the solvent component therein, since no bad electronic influence will be exerted even if the insulating layer 101 which is formed by this solidification does not form a dense layer. However, it is desirable to perform heating processing in order to solidify and strengthen the insulating layer 101.

If the insulating layer 101 is to be solidified by the agency of a chemical reaction, then it has been considered to perform the processing by a chemical such as one which produces the destruction of a dispersal system. For example, if the liquid material 11, 41 has as its main component an organic pigment dispersed in a styrene-acryl resin material, then an aqueous solution of magnesium nitrate may be discharged from the ink jet type head as a reactant liquid. Furthermore, if the liquid material 11, 41 has as its main component an epoxy resin, then an amine type material may be discharged from the ink jet type head as a reactant liquid.

When forming the above described conductive layer 102 or insulating layer 101, after having formed one layer, it is desirable to perform solidification processing upon it before forming the next layer. When liquid material which includes another material K for circuit pattern formation is discharged so as to be superimposed over a liquid material which has not been properly solidified, the materials tend to mix together, and it may happen that the desired electronic characteristics cannot be obtained.

As the material K for formation of a circuit pattern, instead of a material which is endowed with an insulating characteristic, it would also be acceptable to utilize a dielectric material. This is because it is possible to increase the capacitance of the condenser 121 by filling in a dielectric material between its electrodes. Furthermore, it would also be acceptable to form a plurality of insulating layers 101 from a plurality of materials, in parallel with one another. This is because it is possible to obtain a function for the condenser 121 which resembles that of a multi layered structure.

It would also be acceptable to form the insulating layer 101 before forming the conductive layer 102. In particular, if the gap between the electrodes is small, it is desirable to select a material which has an insulating characteristic which is such that the insulating layer 101 exhibits a characteristic of non-affinity with respect to the liquid material 12, 42 which will subsequently be discharged. This is because the danger of the electrodes short circuiting becomes small, since the insulating layer 101 which is formed first repels the liquid material 12, 42.

Furthermore, the conductive layer 102 is not limited to the structure shown in FIG. 4; various other forms are possible therefor. For example, it is possible further to increase the capacitance of the condenser 121 by forming the conductive layer 102 or the insulating layer 101 so that the mutually confronting electrodes are formed in sawtooth shapes or in convex and concave shapes which are engaged together.

It is possible to form the condenser 121 (the circuit pattern P) within the electronic substrate 100 by any of the processes which have been described above. When one of these processes is utilized, if the capacitance of the condenser 121 is found to be insufficient when it is actually measured, small adjustments to the capacitance are possible by forming a further conductive layer 102 so as to widen the area of the mutually confronting electrodes, and/or by discharging a dielectric material between the extended conductive layers 102. In such a case, it is possible to set the condenser 121 which is initially made to a somewhat lower capacitance than that which is desired, and then subsequently to increase the capacitance until it reaches a level which is most suitable.

Since, as has been described above, it is possible to form the insulating layer 101 and/or the conductive layer 102 by an ink jet method, therefore, not only is it possible to manufacture a condenser 121 of any desired type at a low cost with a small scale device such as is utilized in an ink jet printer of the type which is used for a household printer or the like, but, if it is necessary to make small adjustments to the capacity of the condenser 121, it is possible easily to increase its capacitance to a certain extent.

Preferred Embodiment 2

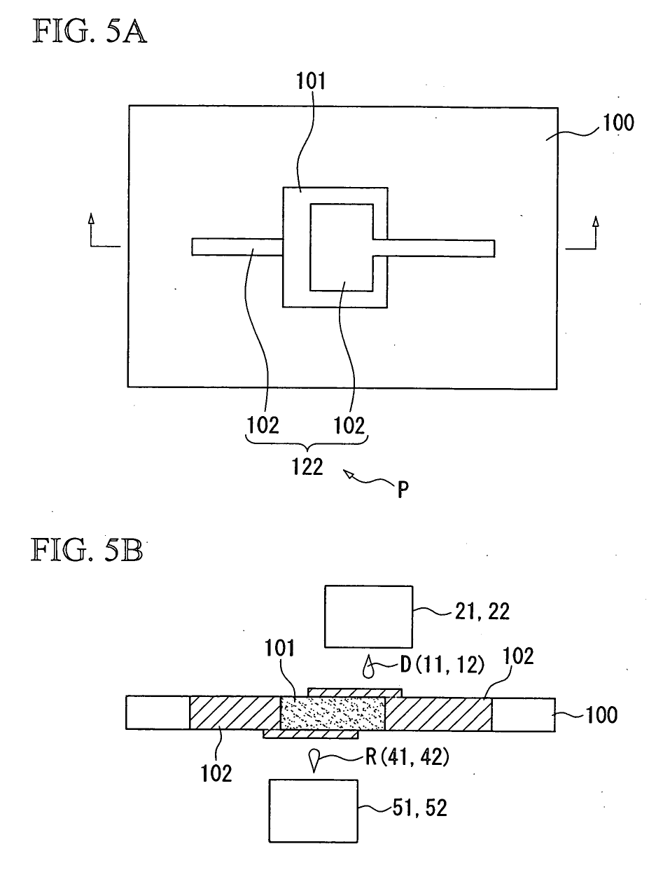

Another example of a method for forming a circuit pattern P of a different type to the above described type (a condenser 122 which has electrodes which face one another in the thickness direction of the electronic substrate 100) by using the above described device 1 for manufacture of an electronic circuit will now be explained with reference to FIGS. 5A and 5B. FIG. 5A is a plan view of an electronic circuit, while FIG. 5B is a sectional view taken in a plane shown by the arrows V-V in FIG. 5A.

Tanks which contain the liquid materials 12, 42 which include a conductive material as the material K for circuit pattern formation, and ink jet type heads 22, 52 which are to discharge these liquid materials including this conductive material, and tanks which contain the liquid materials 11, 41 which include an insulating material as the material K for circuit pattern formation, and ink jet type heads 21, 51 which are to discharge these liquid materials including this insulating material, are provided to this device 1 for manufacture of an electronic circuit.

The process of forming an insulating layer:

The electronic substrate 100 is shifted relative to the ink jet type head 21 which is to discharge the liquid material 11 which is endowed with an insulating characteristic as the material K for circuit pattern formation. As for the nature of this liquid material 11 which is endowed with an insulating characteristic, it is the same as the one described above with reference to the first type of condenser. Although the greater is the width of the insulating layer 101 which is formed, and the thinner that it is, the greater is the capacitance of the resulting condenser 122, the insulating layer 101 must be formed of a sufficient width to provide proper insulation, since otherwise there is a danger of a short circuit occurring between the electrodes. Furthermore, it is possible to increase the capacitance of the condenser 122 by forming the insulating layer 101 from a dielectric material. As for the solidification of this insulating material, it is done in the same manner as described above with reference to the first type of condenser.

The process of forming the upper conductive layer:

The electronic substrate 100 is shifted relatively to the ink jet type head 22 so as to position the ink jet type head 22 over the insulating layer 101 which has been formed, and the insulating layer 101 is shifted relative to the ink jet type head 22 while discharging from the ink jet type head 22 the liquid material 12 which includes a conductive material as the material K for circuit pattern formation, so that the liquid material 12 is discharged as a superimposed layer over the upper surface of the insulating layer 101; and, by solidifying it, an upper side electrode (conductive layer) 102 is formed. The nature of the liquid material 12 which is endowed with conductivity, and the manner of solidifying it, are the same as described above with reference to the first type of condenser. Although it will be acceptable to form the conductive layer 102 in as large a region as possible in order to make the capacitance of the resulting condenser 122 as great as possible, it is necessary to ensure that it does not short circuit with the opposing electrode.

The process of forming the lower conductive layer:

The electronic substrate 100 is shifted relatively to the ink jet type head 52 so as to position the ink jet type head 52 under the insulating layer 101 which has been formed, and the insulating layer 101 is shifted relative to the ink jet type head 52 while discharging from the ink jet type head 52 the liquid material 42 which includes a conductive material as the material K for circuit pattern formation, so that the liquid material 42 is discharged as a superimposed layer over the under surface of the insulating layer 101; and, by solidifying it, a lower side electrode (conductive layer) 102 is formed. The nature of the liquid material 42 which is endowed with conductivity, and the manner of solidifying it, are the same as described above.

Although the conductive layer 102 which is to become the lower side electrode permeates into the electronic substrate 100 if the insulating layer 101 has not permeated through as far as the under surface of the electronic substrate 100, by contrast, if the insulating layer 101 does indeed permeate as far as the under surface of the electronic substrate 100, then said conductive layer 102 which is to become the lower side electrode becomes layered underneath the insulating layer 101. However, the lower conductive layer 102 must of course be formed so as not to short circuit with the upper electrode 102.

It is possible to form the condenser 122 (the circuit pattern P) within the electronic substrate 100 by this process. It should be understood that, if it is desired to change the capacitance of the condenser 122 afterwards, then it is possible easily to do so by, after having performed a forming operation using an ink jet method in order to make the insulating layer 101 larger, additionally forming extra portions for the upper electrode and for the lower electrode upon the upper and lower sides of the insulating layer 101 which has been thus increased, so as to increase the mutually confronting area of the electrodes.

With this condenser 122, the layer which is created between the upper and lower electrodes 102, 102 is not limited to being an insulating layer; it would also be acceptable to form a non affinity layer which exhibits the characteristic of non affinity with respect to the liquid material 12 which includes the conductive material. This is because, if the insulation characteristic of the electronic substrate 100 is sufficient by itself, it is possible to reduce the danger of the upper electrode 102 and the lower electrode 102 short circuiting together by the use of a non affinity layer which repels the liquid materials 12, 42.

Since, according to this method, it is possible to form the insulating layer and/or the conductive layer 102 by an ink jet type method, accordingly, it is possible to make a condenser of any desired shape with a small scale device such as is used in an ink jet printer of the time which is employed as a household printer or the like, and moreover at a low cost. Furthermore, according to this method, it is possible to manufacture a condenser 122 of high capacitance, since it is possible to set the area of the electrodes relatively large.

Preferred Embodiment 3

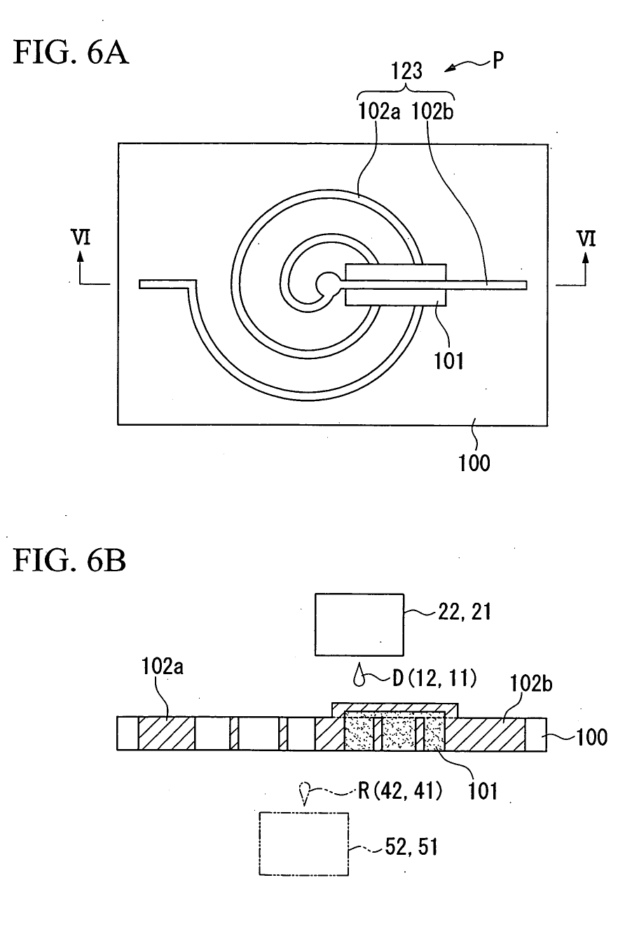

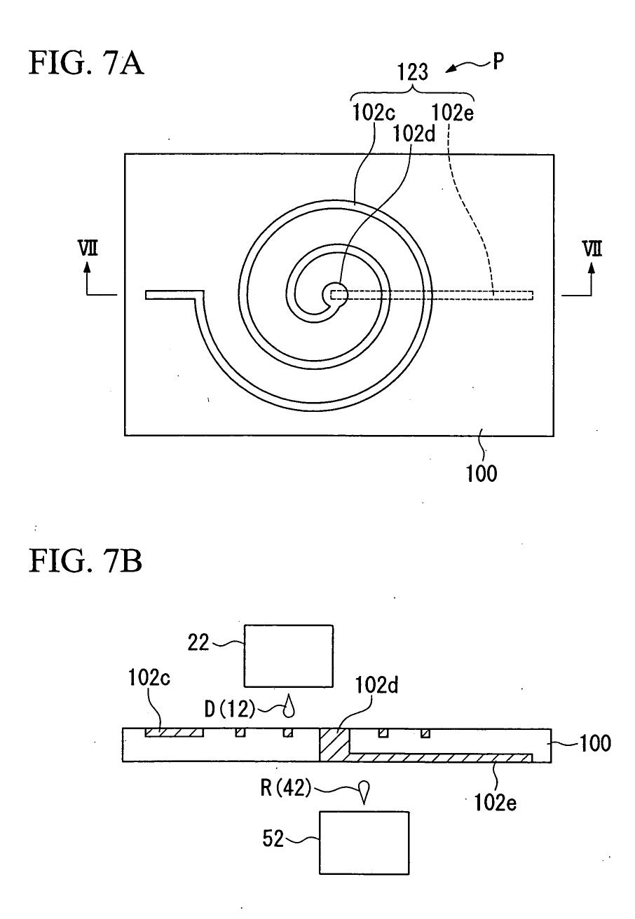

Next, an example of a method for forming a coil (an inductance) 123 as a circuit pattern P by using the above described device 1 for manufacture of an electronic circuit will now be explained with reference to FIGS. 6A, 6B, 7A and 7B. FIGS. 6A and 7A are plan views of an electronic circuit, while FIG. 6B is a sectional view taken in a plane shown by the arrows VI-VI in FIG. 6A, and FIG. 7B is a sectional view taken in a plane shown by the arrows VII-VII in FIG. 7A.

In the device 1 for manufacture of an electronic circuit, there are included tanks for containing liquid material 12, 42 which contains a conductive material as the material K for circuit pattern formation, ink jet type heads 22, 52 which discharge this liquid material 12, 42, tanks for containing liquid material 11, 41 which contains a material which has an insulating characteristic as the material K for circuit pattern formation, and ink jet type heads 21, 51 which discharge this liquid material 11, 41.

The process of forming a spiral conductive layer:

While discharging the liquid material 12, 42 which contains a conductive material from the ink jet type heads 22, 52, the electronic substrate 100 is relatively shifted with respect to the ink jet type heads 22, 52 as shown in FIG. 6A in a helical pattern, so that a conductive layer 102a is formed as a spiral. The number of turns in this spiral conductive layer 102a, and its width, are determined according to the value of the inductance of the coil 123 which it is desired to manufacture. With regard to the nature of the liquid material 12, 42, and the process of solidification thereof, these are the same as previously discussed above.

The process of forming an insulating layer:

While discharging the liquid material 11, 41 which contains a material which is endowed with an insulating characteristic from the ink jet type heads 21, 51, the electronic substrate 100 is relatively shifted with respect to the ink jet type heads 21, 51 as shown in FIG. 6A, so that an insulating layer 101 is formed in the form of a band which extends along the diametrical direction of the spiral conductive layer 102a, leaving the central point of the spiral uncovered. By doing this, along with the insulating layer 101 being formed by permeation between the spiral lines of the conductive layer 102a, the conductive layer 102a is also formed as a superimposed layer over these spiral lines of the conductive layer 102a. With regard to the nature of the liquid material 11, 41, and the process of solidification thereof, these are the same as previously discussed above.

The process of forming a further conductive layer:

While discharging the liquid material 12 which contains the conductive material from the ink jet type head 22, the electronic substrate 100 is relatively shifted with respect to the ink jet type head 22, so that a conductive layer 102b which corresponds to a line which extends out from the coil 123 is formed over the insulating layer 101, thereby passing over the insulating layer 101 and moreover connecting together the central point of the spiral shape of the coil 123 and the outside. Since, by doing this, it is possible to form the conductive layer 102b which corresponds to the line which extends out over the insulating layer 101, thereby the conductive layer 102b is formed which leads out from the center of the spiral form of the coil 123 without coming into contact with the conductive layer 102a which constitutes this spiral form (except at its center point), and accordingly it is possible to form the coil 123. With regard to the nature of the liquid material 12 and the process of solidification thereof, these are the same as previously discussed above.

By this process, it is possible to form the coil 123 as a circuit pattern P upon the electronic substrate 100. It should be understood that it would also be acceptable to connect a per se conventional lead wire to the central point of the conductive layer 102a which constitutes the spiral of the coil 123, instead of forming the insulating layer 101 and the conductive layer 102b which corresponds to a lead out line.

Furthermore, by adjusting the depth of the conductive layer 102 which is permeated into the electronic substrate 100, it would also be possible to form the coil 123 without providing the insulating layer 102. In other words, as shown in FIG. 7, it is possible to discharge only the liquid material 12 which is endowed with conductivity against only the upper surface of the electronic substrate 100 by using only the ink jet type head 22, and to form a relatively thin conductive layer 102c in the form of a spiral only upon the upper surface side of the electronic substrate 100. Next, a conductive layer 102d is formed at the central portion of this spiral form by discharging both the liquid materials 12, 42 which are endowed with conductivity against both the upper surface and the lower surface of the electronic substrate 100 by using both of the ink jet type heads 22, 52, while shifting the electronic substrate 100 with respect to the ink jet type heads 22, 52, so that these liquid materials 12, 42 permeate into both the upper surface and the lower surface of the electronic substrate 100. Furthermore, another relatively thin conductive layer 102e is formed only upon the under surface of the electronic substrate 100 by discharging only the liquid material 42 which is endowed with conductivity against only the lower surface of the electronic substrate 100 by using only the ink jet type head 52, so as to correspond to a lead out line which is extended from the conductive layer 102d at the center of the spiral shape of the coil 123 to the outside of the conductive layer 102c; and thereby it is possible to form the coil 123 without providing any insulating layer 102.

Yet further if, after having formed the coil 123, it were to be desired to increase the value of the inductance of this coil 123, it would be acceptable to further extend the spiral conductive layer 102a, 102c from the end portion of its spiral. It would also be possible to paint a magnetic material between the conductive layers 102a, 102c of the spiral shape so as to increase the value of the inductance of the coil 123. On the other hand if, after having formed the coil 123, it were to be desired to decrease the value of the inductance of the coil 123, then it would be possible additionally to form a lead out line from an intermediate point of the spiral conductive layer 102 which had already been formed.

As described above, according to the present invention, it is possible to manufacture a coil 123 as a circuit pattern P within the electronic substrate 100. Furthermore, if after manufacture of such a coil 123 it is desired to increase or to decrease the value of its inductance or the like, it is easily possible to perform such fine adjustments. It should be understood that if, without forming the conductive layer 102 in the form of a spiral, instead the conductive layer 102 is formed in a serrated or sawtooth shape, or in a concave and convex shape, then it is also possible to obtain a desired inductance value for the coil element 123, in the same manner as in the case of forming a spiral shaped conductive layer 102.

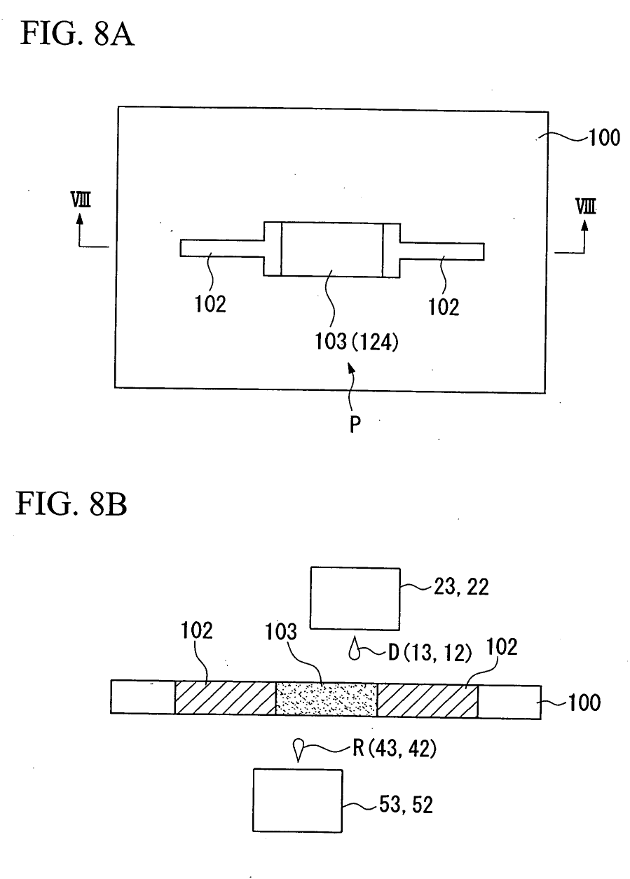

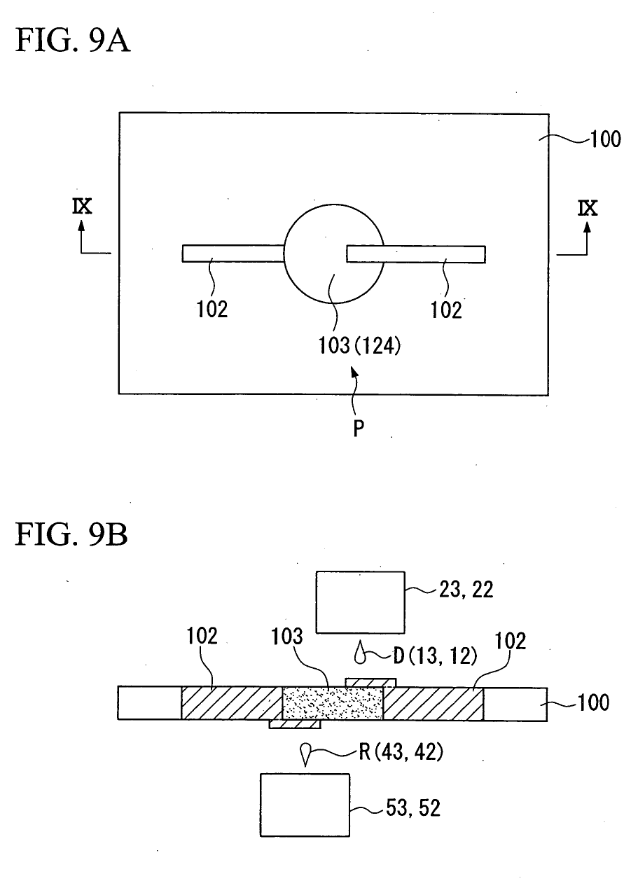

Next, an example of a method for forming a resistor 124 (a circuit pattern P) by using the above described device 1 for manufacture of an electronic circuit will now be explained with reference to FIGS. 8A, 8B, 9A and 9B. In these drawings, FIGS. 8A and 9A are plan views of an electronic circuit, while FIG. 8B is a sectional view taken in a plane shown by the arrows IIX-IIX in FIG. 8A, and FIG. 9B is a sectional view taken in a plane shown by the arrows IX-IX in FIG. 9A.

In the device 1 for manufacture of an electronic circuit, there are included tanks for containing liquid material 13, 43 which contains a resistive material as the material K for circuit pattern formation, and ink jet type heads 23, 53 which discharge this liquid material 13, 43.

The type of the resistive material which is included in the liquid material 13, 43 as the material K for circuit pattern formation is determined according to the value of the resistance of the circuit pattern P (the resistor 124) which it is desired to produce. In this liquid material 13, 43, as the resistive material, there may be suggested a mixture of a conductive powder and a powder which has an insulating characteristic, such as Ni-Cr, Cr-SiO, Cr-MgF, Au-SiO₂, AuMgF, PtTa₂O₅, AuTa₂O₅Ta₂, Cr₃Si, TaSi₂, or the like; and, as a solvent for this mixture, there may be suggested PGMEA, cyclohexane, carbidol acetate, or the like. According to requirements, it would also be acceptable to add to the liquid material 13, 43, as a humectant and also as a binder, glycerin, diethylene glycol, ethylene glycol, or the like. As the liquid material 13, 43, it would also be possible to utilize a metallic alkoxide including polysilazane or an insulating material. In this case, it would be possible to form an insulating material by heating up, or by a chemical reaction or the like.

The process of forming a resistive layer:

While shifting the electronic substrate 100 relatively with respect to the ink jet type heads 23, 53, the liquid materials 13, 43 which include the resistive material as the material K for circuit pattern formation are respectively discharged in a continuous manner from the ink jet type heads 23, 53 against the upper and the lower surfaces of the electronic substrate 100. By doing this, a resistive layer 103 is formed which has the attribute of electrical resistance. With regard to the process of solidification of this resistive layer 103, it is executed in a manner as described above. It should be understood that the width, the thickness, and the length of this resistive layer 103 which is formed are determined according to the value which is desired for the resistance of the resulting resistor 124. This is because the value of the resistance of the resistor 124 is proportional to its length and inversely proportional to its cross sectional area. It should be understood that it is desirable to set the width, the thickness, and the length of this resistive layer 103 so as to obtain a resistance value which is somewhat greater than the resistance value which is the target. This is because it is possible to reduce the resistance value to a suitable resistance value by increasing the depth or the width of the resistive layer 103 at a later stage, if so desired.

The process of forming a conductive layer:

When the resistive layer 103 has been solidified, the electronic substrate is shifted relative to the ink jet type heads 22, 52 while discharging the liquid material which is endowed with conductivity from these ink jet type heads 22, 52, and thereby conductive layers 102, 102 are formed at both the ends of the resistive layer 103. With regard to the process of solidification of these conductive layers 102, it is executed in a manner as described above. It should be understood that, as shown in FIG. 9, it would also be possible, without forming the conductive layers 102 at both the ends of the resistive layer 103, instead to form a resistor 124 of a structure in which the conductive layers 102 were formed upon the upper surface side and upon the lower surface side of the resistive layer 103. The details of this alternative process will be clear to a person of ordinary skill in the art, based upon the explanations given above, and accordingly they are curtailed herein.

It is thus possible to form a resistor 124 as a circuit pattern P within the electronic substrate 100 by this process. It should be understood that if, after the resistor 124 has been initially provisionally formed, it is desired to make a small adjustment to the resistance value of this resistor, then it is possible to lower the value of the resistance to any desired and appropriate value by discharging further quantities of the liquid material 13, 43 and increasing the thickness or the width of the resistive layer 103. It is thus easily possible to manufacture a resistor 124 as an electronic circuit by this type of ink jet method. Furthermore, it is also possible to make small adjustments to the value of the resistance of the resistor, after it has been initially produced.

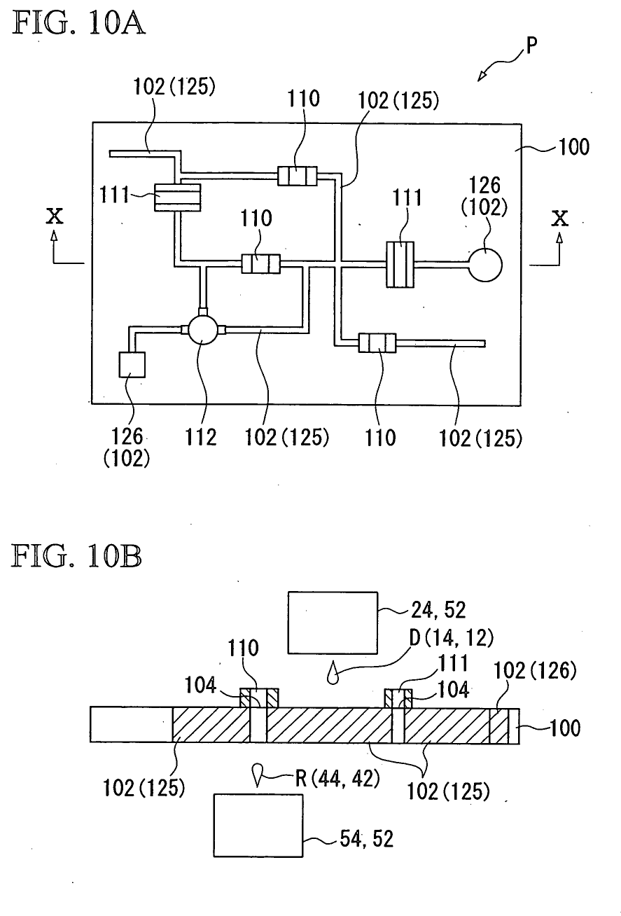

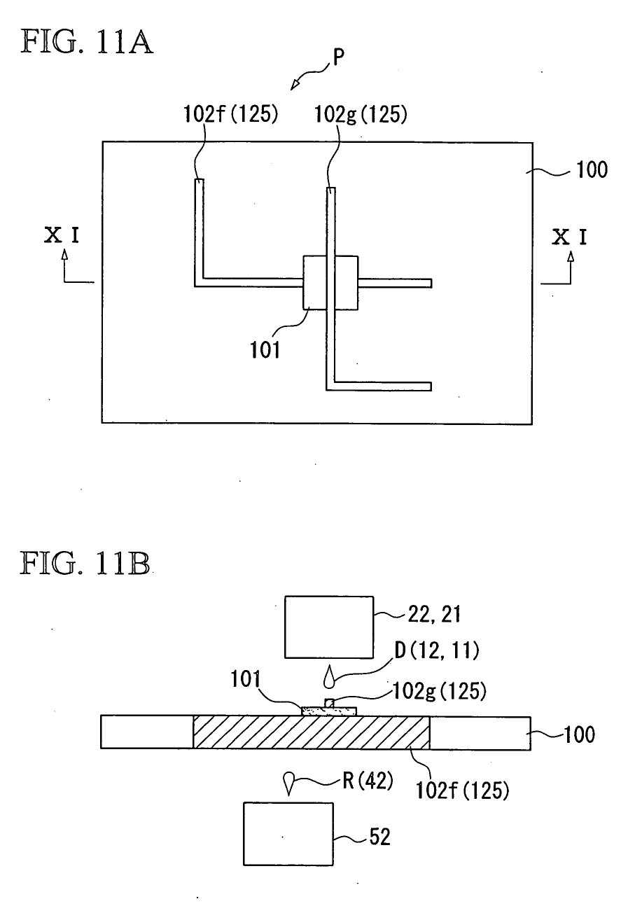

Next, an example of a method for forming lead wires 125 and electrodes 126 by using the above described device 1 for manufacture of an electronic circuit will now be explained with reference to FIGS. 10A, 10B, 11A and 11B. In these drawings, FIGS. 10A and 11A are plan views of an electronic circuit, while FIG. 10B is a sectional view taken in a plane shown by the arrows X-X in FIG. 10A, and FIG. 11B is a sectional view taken in a plane shown by the arrows XI-XI in FIG. 11A.

The above described device 1 for manufacture of an electronic circuit is used for the process of forming these lead wires 125 and electrodes 126. And, while using discrete components as circuit elements, as per se practiced in the prior art, the present invention can be applied to formation of the lead wires between these discrete components. However, a further device or a manual component arrangement process is required in order to arrange these discrete components upon the upper surface or the lower surface of the electronic substrate 100.

The process of component arrangement:

Individual components (discrete components) are arranged in appropriate positions upon the upper surface or the lower surface of an electronic substrate 100 by using an insertion machine or by hand. This arrangement is determined according to the circuit pattern P (the electronic circuit C) which it is desired to manufacture. In FIG. 10, by way of example, the case is shown in which, as these individual components, resistors 110, condensers 111, and a transistor 112 are thus arranged in chip form.

It is desirable to attach these individual components 110, 111, and 112 to the electronic substrate 100 in advance by using an epoxy adhesive or the like. It is also desirable to perform the application of this adhesive material by an ink jet method as well. For example, an adhesive layer 104 may be formed by discharging a liquid material 14, 44 which includes an adhesive material from the ink jet heads 24, 54 in regions of the electronic substrate 100 where the components are to be adhered. Since this adhesive layer 104 is only required to hold the components in place, it is desirable to utilize a material which does not permeate into the electronic substrate 100. Furthermore, it will also be acceptable to form the adhesive layer 104 in a region which is smaller than the actual area which is covered by the components. And, it will be acceptable to stick the components in place over the adhesive layer 104 with an insertion machine or the like. It should be understood that an epoxy resin or a resin which can be hardened by energy or the like should be employed as the adhesive material. For example, if a thermosetting resin or a photo-setting resin is used, then it is possible to stick on the components using irradiation by heat or by light, without any problem of hardening of the material which remains in the ink jet type heads 24, 54.

The lead wire process:

When the various individual components have been stuck on to the electronic substrate 100, then lead wires 125 (a conductive layer 102) which connects between these components is formed by using a liquid material 12, 42 which includes a conductive material as its material K for circuit pattern formation. The nature of this conductive material, and the details of its application and solidification, are the same as discussed above, and accordingly description thereof will be eschewed. It is also possible to form these lead wires 125 so that they extend, not only along the surface directions (the X and Y directions) of the electronic substrate 100, but also through it along its thickness direction (the Z direction).

Furthermore, by discharging the liquid material 12, 42 in a concentrated manner, it is also possible to form electrodes (conductive layers 102) which can be connected to lead wires or the like from the outside, partway along the lead wires 125. Such electrodes 126 may be formed in any desired form, such as circular form, square form, triangular form, rectangular form, or the like.

It should be understood that it would also be acceptable to attach between the lead wires 125 which are constituted by the conductive layer 102 and certain terminals of the various components by soldering. It is also possible easily to perform this soldering operation by an ink jet method, in which solder is heated up to a temperature above its melting point and is discharged from an appropriate one of the ink jet type heads 20, 50.

Furthermore, if the pattern of the lead wires 125 involves an intersection, as shown in FIG. 11, it will be acceptable, after having formed a conductive layer 102f which will constitute an underneath layer, to provide an insulating layer 101 over this conductive layer 102f at the point where this intersection is to be located, and then to form a further conductive layer 102g over this insulating layer 101.

It should be understood that although, in the above description of the manufacture of the lead wires 125 by an ink jet method, it was assumed that the individual components were made separately by per se conventional means, it would also be acceptable to manufacture a portion or the entirety of the circuit elements with this type of ink jet method, as previously described. In other words, it would be possible to utilize a separate component in the case of a condenser of high capacitance value, a coil of high inductance value, or an active element of a complicated structure, while forming other less demanding circuit elements in an easy manner within the electronic substrate 100 by using an ink jet method as has already been described. It should be understood that although, in the example described above, the arrangement of the components was performed first, it would also be possible to make the lead wires 125 first.

With this process, it is possible to form lead wires 125 and/or electrodes 126 as circuit patterns P within the electronic substrate 100. Furthermore, in the case of utilizing separate components as described above as well, it is also possible to form their lead wires 125 and/or electrodes 126 in an easy manner with this type of ink jet method.

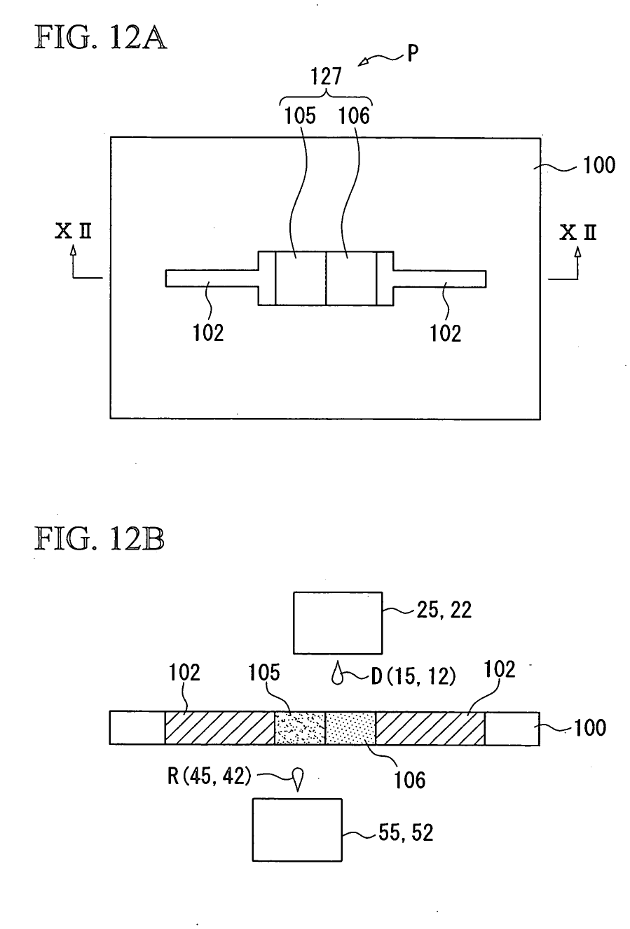

Next, an example of a method for forming an active element 127 (a circuit pattern P) such as a diode or a transistor or the like by using the above described device 1 for manufacture of an electronic circuit will now be explained with reference to FIGS. 12A and 12B. In this drawing, FIG. 12A is a plan view of an electronic circuit, while FIG. 12B is a sectional view taken in a plane shown by the arrows XII-XII in FIG. 12A.

The above described device 1 for manufacture of an electronic circuit is utilized for forming this active element 127. This device 1 for manufacture of an electronic circuit comprises tanks which hold a liquid material 15, 45 which includes, as its material K for forming a circuit pattern, a semiconducting material, and ink jet type heads 25, 55 which discharge this liquid material 15, 45. As this semiconducting material, an element such as silicon or germanium or the like doped with an appropriate substance may be utilized, as appropriate. It will be acceptable to perform the doping after this process according to the present invention for formation of the active element 127 has been completed.

And, as shown in FIGS. 12A and 12B, it is possible to form the active element 127 such as a diode or a transistor or the like by layering together a multiple electron carrier semiconductor layer 105 (an n layer) and a multiple positive hole carrier semiconductor layer 106 (a p layer) along the direction of the surface of the electronic substrate 100, i.e. along its X-Y direction, in any of various shapes, while adjusting the carrier density thereof. Alternatively, it is possible to form the active element 127 such as a diode or a transistor or the like by layering together such semiconductor layers 106 and 107 in the thickness direction of the electronic substrate, i.e. in its Z direction (this possibility is not shown in the drawing). In other words, it becomes possible to manufacture a semiconductor element of the type which has been, in the prior art, manufactured by epitaxial growth, by the ink jet method according to the present invention. That is, it is possible to manufacture any of various per se known semiconductor elements which are currently manufactured by a conventional process, by forming an identical layered structure using the ink jet method according to the present invention.

By doing this, it is possible to form the active element 127 within the electronic substrate 100as a circuit pattern P.

As has been explained above in terms of the presentation of various examples, according to the present invention, it is possible to manufacture within the electronic substrate 100 an electronic circuit C in which various circuit patterns P are formed as solid bodies. In other words, since the circuit patterns P are formed within the electronic substrate 100, it is possible to reduce the thickness of the electronic circuit C, as compared with a case in which circuit patterns P are formed upon the surface of an electronic substrate 100, and accordingly it is possible to reduce the size and the weight of the electronic circuit C. Furthermore, since an electronic substrate 100 is used which is made from a porous ceramic material, accordingly this electronic substrate 100 exhibits an excellent capillary action, so that the various liquid materials 10, 40 which include their various materials K for circuit pattern formation are absorbed at high speed into the electronic substrate 100, and accordingly it is possible to form the various circuit patterns P at high speed and at high accuracy. Yet further, by using various different types of material K for circuit pattern formation, it is possible to form a high performance electronic circuit C which includes various different types of component, such as the condensers 121 and 122, the reactance 123, the resistor 124, the lead wires 125, the electrodes 126, and the active element 127 and so on described above.

It should be understood that the operational procedures which have been described above in connection with the various preferred embodiments of the present invention, and the various shapes and assemblies of various structural elements and so on, are only particular and individual examples; provided that the gist of the present invention is adhered to, it is possible to vary any or all of these details, based upon requirements for process conditions or constructional details. The present invention also should be considered as including variations such as those described by way of example below.

The present inventions is not limited to the case of making a circuit pattern P which comprises a plurality of elements such as the condensers 121 and 122, the reactance 123, the resistor 124, the lead wires 125, the electrodes 126, and the active element 127 and so on; it could also be utilized for the manufacture of individual components such as the condensers 121 and 122, the reactance 123, the resistor 124, the lead wires 125, the electrodes 126, and the active element 127 and so on.

It would also be acceptable to discharge liquid materials 10, 40 (including materials K for circuit pattern formation) composed of different substances at the same time against the same position upon the electronic substrate 100 from the ink jet type heads 20, 50 which oppose it. By doing this, it would be possible to form two layers of circuit pattern P, superimposed upon one another along the thickness direction (the Z direction) of the electronic substrate 100.

Furthermore, although in the above described preferred embodiments of the present invention the ink jet type heads 20, 50 were arranged so as to confront the electronic substrate 100 from both its sides, the present invention is not to be considered as being limited to this arrangement; it would also be possible for ink jet type heads to be arranged to confront only the upper surface, or only the lower surface, of the electronic substrate 100. In such a case, it would be possible to obtain the same beneficial results as in the case of the various preferred embodiments described above by supplementing operations upon the back side of the electronic substrate 100.

The electronic substrate 100 is not to be considered as being limited to being a porous ceramic material; it is only necessary for it to be endowed with an appropriate degree of permeability. Accordingly, it would also be possible to utilize paper, plastic, or the like. However, it is necessary for it to be possible to perform hardening processing upon the electronic substrate 100. Furthermore, the electronic substrate 100 is not to be considered as being limited to a material which is endowed with an insulating characteristic. Although, in the case of an electronic substrate 100 which is thus endowed with an insulating characteristic, the manufacture of a circuit pattern P is principally performed by discharging conductive material, by contrast, in the case of an electronic substrate 100 which is endowed with conductivity, the manufacture of a circuit pattern P would advantageously be principally performed by discharging insulating material.

Yet further, it would be possible to manufacture a multi layered substrate by superimposing a plurality of electronic substrates which had been manufactured according to the present invention. In such a case, it would be desirable to prevent short circuiting between the various circuit patterns P upon the adjacent electronic substrates 100 by painting an insulating material upon the contacting surface of least one of them.

Still further, although, in the preferred embodiments of the present invention which have been described above, the electronic substrate 100 was shifted with respect to the ink jet type heads 20, 50 by the stage device 70, the present invention is not to be considered as being limited to this form of construction; the only requirement is that a construction should be provided for mutually shifting the electronic substrate 100 and the ink jet type heads 20, 50 with respect to one another. As alternative variants for such a construction, it would be acceptable for the ink jet type heads 20, 50 to be shifted relatively to the electronic substrate 100, or for both the ink jet type heads 20, 50 and the electronic substrate 100 to be shifted.

The liquid material 10, 40 which is discharged from the ink jet type heads 20, 50 is not to be considered as being limited to the various materials K for circuit pattern formation described by way of example above; it may include an adhesive substance, a substance which is endowed with a repellent characteristic, a pigment, or the like. Furthermore, it would also be possible to incorporate an adhesive substance, a substance which is endowed with a repellent characteristic, a pigment, or the like into the material K for circuit pattern formation.

Finally, the circuit pattern P which is formed by this ink jet method is not limited to being an electronic circuit; it would also be possible to form a mechanical or a decorative object upon an electronic substrate 100 or the like. This is because it would thus be possible to experience the beneficial feature of such an ink jet method in its pristine aspect—that is, the ability to form a minute pattern easily with low cost equipment.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An electronic substrate, made from a porous material into which a fluid material which includes a material for formation of a circuit pattern can permeate.

2. An electronic substrate according to claim 1, wherein a main component of said porous material is a ceramic.

3. An electronic substrate according to claim 1, wherein a main component of said porous material is a fiber material.

4. An electronic circuit, comprising an electronic substrate according to claim 1, and a circuit pattern which is formed by said liquid material permeating into said electronic substrate and solidifying.

5. An electronic circuit according to claim 4, wherein, as said material for circuit pattern formation, said liquid material comprises at least one of a conductive material, a semiconducting material, an insulating material, and a dielectric material.

6. An electronic circuit according to claim 5, wherein said circuit pattern includes a condenser which is formed from said material for circuit pattern formation.

7. An electronic circuit according to claim 5, wherein said circuit pattern includes an inductance which is formed from said material for circuit pattern formation.

8. An electronic circuit according to claim 5, wherein said circuit pattern includes a resistor which is formed from said material for circuit pattern formation.

9. An electronic circuit according to claim 5, wherein said circuit pattern includes a lead wire or an electrode which is formed from said material for circuit pattern formation.

10. An electronic circuit according to claim 5, wherein said circuit pattern includes an active element which is formed from said material for circuit pattern formation.

11. A method for manufacture of an electronic circuit, in which a circuit pattern is formed upon a permeable electronic substrate by permeating a liquid material which includes a material for circuit pattern formation thereinto and solidifying it.

12. A device for manufacture of an electronic circuit which forms a desired circuit pattern upon a permeable electronic substrate using a liquid material which includes a material for circuit pattern formation, comprising an ink jet type head which discharges said liquid material against said electronic substrate, and a shifting device which relatively shifts said ink jet type head and said electronic substrate with respect to one another.
